(19) United States
(12) Patent Application Publication
(10) Pub. No.: US 2013/0218601 A1
(43) Pub. Date: Aug. 22, 2013

(54) ELECTRONIC MULTIPURPOSE CARD AND METHOD OF USING SAME

(71) Applicant: Richard Webb, Santa Ana, CA (US)

(72) Inventor: Richard Webb, Santa Ana, CA (US)

(21) Appl. No.: 13/847,954

(22) Filed: Mar. 20, 2013

Related U.S. Application Data
(63) Continuation-in-part of application No. 12/713,023, filed on Feb. 25, 2010.

(51) Int. Cl. G06K 19/07; G06Q 50/24; G07F 17/32

(52) U.S. Cl. CPC G06K 19/0718; G07F 17/3206; G06Q 50/24
USPC 705/3; 235/492; 463/29; 463/25

(57) ABSTRACT

An electronic multipurpose card includes a biometric reader element for card activation and at least one interface connection for an external processor. A programmable memory is connected to the element and at least one port receives an additional memory module. A programmable magnetic stripe memory element stores data and a program selects among alternative data sets and alternative instruction sets input by either of the card issuer or the card user. A selection device is activated by the user to operate the application program and effect selection of any of the alternative data sets and the alternative instruction sets. The card has applications where the data and instructions stored on the card should only be available to a user for whom the card was issued. These applications include proprietary health care data and online gambling. A time out feature is included to prevent unauthorized use of the card after authorization.

### RELATED APPLICATION

The instant application is a Continuation-in-Part of U.S. application Ser. No. 12/713,023 filed Feb. 25, 2010, which claims the benefit of U.S. Provisional Application Ser. No. 61/155,863, filed Feb. 26, 2009, and incorporates the disclosure of the parent applications in their entirety.

### FIELD OF INVENTION

This invention relates to the field of personal electronic data cards, and more specifically to cards incorporating cardholder identification systems memory storage features and connectivity facilities.

### BACKGROUND OF THE INVENTION

Modern economic, transactions often take place through the use of convenient, pocket-sized cards. These include not only credit and debit cards, but also health insurance cards, club membership cards, parking entry cards, hotel room key cards, online gambling cards and various types of membership cards. A busy, urban individual may be carrying a dozen or more cards just to conduct his or her normal daily affairs. Most, if not all of these cards are encoded with electronic information which is personal and proprietary. Often the disclosure of this information by third parties can lead to legal liability. For these reasons the present invention offers solutions that include. the incorporation of data for multiple cards into a single “intelligent” data card, and various means for insuring the security of not only the data on the card, but verifying who is using the card. In addition, the cards of the present invention provide multiple means for both receiving data from outside sources and transmitting data to remote systems.

U.S. Pat. No. 4,683,372, issued to Matsumoto, discloses a card with an integral integrated circuit. (IC) that has a data processing function and allows a wide range of applications. Due to its convenience, the IC card is assumed to replace conventional magnetic stripe cards (MS). With the use of an IC memory, the IC card has an improved data storage capacity. Unlike conventional MS cards, data reading, which is not passive, enhances security by eliminating access by a wrong terminal. Thus an IC card promises the use of one card for many different terminals by a holder. The current problem is, therefore, how to assure the storage of a number of different data in the card.

U.S. Pat. No. 7,360,688 issued to Harris is directed to a new credit card system which enables improved reading and other operations. Reading can be done in the short edge of the credit card thereby shortening the aspect ratio and size of the card reader. The reader can be electrical, reading information via contacts, or can be optical readers.

U.S. Pat. No. 5,578,808 issued to Taylor illustrates a multi-application data card is capable of substituting for a plurality of existing single-application data. cards. The multi-application data card is preferably a smart card recording data relating to a card user and a plurality of card issuers. The following fields are associated With each card issuer; an application code field indicating a type of application provided for the user by the issuer; a PIN field identifying the user; an access code field whereby the card issuer can have access to the fields associated with that issuer but not to fields associated with any other issuer; an account number field; an expiration date Field; and a miscellaneous data field provided for the issuer to record additional data to facilitate its operations. The fields associated with each issuer are separate from the fields associated with every other issuer.

U.S. Pat. No. 4,736,094, issued to Yoshida disclose a financial transaction processing system comprising an integrated circuit (IC) card fur use in transaction with a financial body, terminals communicating with the IC card and centers provided for each financial body. The IC card comprises a read only memory for storing data for specifying transaction accounts corresponding to a plurality of financial bodies and data of a single secret number common to the financial bodies. When the IC card is inserted into the terminal, a customer can designate a specific account which he wishes to use, by operating a keyboard provided in each of the terminals. In response to such designation, the corresponding account specifying data is read out from the ROM, but if the corresponding account is not stored in the ROM, a transaction cannot be made. In addition, the account specifying data as read out and a claimed amount entered by a customer are sent to a center for the financial institutions carrying account where processing for payment is performed. However, if and when the balance is not sufficient, the center instructs the customer to select another account. A random access memory included in the IC card is made to store the amount after payment processing in the center, so that a transaction can be made with a cash dispensing terminal in an offline manner, by using such an IC card.

U.S. Pat. No. 4,874,935, issued to Younger is directed to a smart card including a microcomputer. The microcomputer is programmed with a smart card control program and a data dictionary defining the data to be stored in the microcomputer.

It is an objective of the present invention to provide an electronic multipurpose card that includes the functionality of multiple credit, debit or other electronic data cards. It is a further objective to provide such a card that allows the user to easily select the desired functionality for the card. It is a still further objective of the invention to provide a card that can determine if the holder of the card is the authorized user. It is yet a further objective to provide a multipurpose card that includes removable data storage features. It is still a further objective to provide a card that can store multiple online data connection addresses and activate an address determined by the physical location of the card. Finally, it is an objective of the present invention to provide a card that includes multiple means for connecting the card to online systems.

While some of the objectives of the present invention art disclosed in the prior art, none of the inventions found include all of the requirements identified.

### SUMMARY OF THE INVENTION

The present invention addresses all of the deficiencies of prior electronic multipurpose card inventions and satisfies all of the objectives described above.

(1) An electronic multipurpose card providing the desired features may be constructed from the following components. A biometric reader element for activating the card is provided. At least one interface connection element for connection to an external computer processor is provided. A programmable memory connected to the interface connection element is provided. At least one port is provided. The port receives at least one additional memory module. A programmable magnetic stripe memory element is provided.

An application program is provided. The program selects among alternative data sets input by either of a card issuer or a card user. The program selecting among alternative instruction sets input by either of the card issuer or the card user. A selection device is provided. The device is activated by the card user to operate the application program and effect selection of any of the alternative data sets and the alternative instruction sets.

(2) In another variant of the invention, the biometric reader element is selected from the group that includes fingerprint reader, skin conductivity reader, retinal scanner, facial recognition system and embedded chip detector.

(3) In still another variant, the at least one interface connection element is selected from the group that includes USB connector, mini USB connector, micro USB connector and Apple® proprietary connector.

(4) In a further variant, the programmable memory is imbedded in the card.

(5) In still a further variant, the additional memory module is selected from the group that includes SD® cards, Memory Sticks®, Compact Flash® cards, and Smart Memory® cards.

(6) In yet a further variant, the selection device is an array of switches attached to the card.

(7) In another variant of the invention, the selection device is any of a touchscreen on the card, a remotely connected keyboard and a remotely connected touchscreen.

(8) In still another variant, an onboard microprocessor connected to the at least one interface connection element is provided.

(9) In a further variant, a radio frequency identification device (RFID) is connected to the programmable memory.

(10) In still a further variant, the electronic multipurpose card further includes any of a Bluetooth® connection device, wireless connection device or wired connection.

(11) In yet a further variant, the electronic multipurpose card further includes a scannable, identifying barcode.

(12) In another variant of the invention, any of a two dimensional, scannable, identifying barcode (QR code) and three dimensional holographic code is provided.

(13) In still another variant, any of a mobile phone, tablet computer and other computer-based application program is provided. The program connects to and interfaces with either of the onboard microprocessor and the programmable memory through the at least one interface connection element.

(14) In yet another variant, a mobile phone case is provided. The case is adapted to connect the card to a mobile phone. The phone provides the application program to interface with either of the onboard microprocessor or the programmable memory.

(15) In a further variant, a Web-based or local computer-based application program is provided. The program connects to and interfaces with either of the onboard microprocessor or the programmable memory through the at least one interface connection element.

(16) In still a further variant, a time delay system is provided. The time delay system renders user data sets or instruction sets available from the card unreadable by external devices after a preselected time period without renewed authorizing input from a card user.

(17) In yet a further variant, user information on the card is transmitted to an external memory device through the at least one interface connection element.

(18) In another variant of the invention, user data sets or instruction sets on the card are used to supplement a payment made with another card or device.

(19) In still another variant, user data sets or instruction sets on the card are used to access a user's financial institution to recharge the card for use as any of a debit card and financial transaction device for further transactions.

(20) In yet another variant, a method of using an electronic multipurpose card for online gambling includes the steps of:
providing an electronic multipurpose card that includes:
   a biometric reader element for activating the card;
   at least one interface connection element for connection to an external computer processor;
   a programmable memory connected to the interface connection element;
   at least one port, the port receiving at least one additional memory module;
   a programmable magnetic stripe memory element:
   an application program, the program selecting among alternative data sets input by either of a card issuer and a card user;
   the program selecting among alternative instruction sets input by either of the card issuer and the card user; and
   a selection device, the device activated by the card user to operate the application program and effect selection of any of the alternative data sets and the alternative instruction sets.
providing at least one online gambling website, the website has a website address and includes software adapted to determine a geographic location for any electronic device connecting to the website;
inputting at least one data set to the card includes the online gambling website address and a geographic address of a gambling institution;
inputting at least one instruction set to the card for providing connection to the website address upon activation of the card;
verifying an identity of a client of the gambling institution;
issuing the electronic multipurpose card to the client;
setting up any of a password, personal identification number (PIN) and identifying code for use by the client with the card;
attaching the card to a computer using the interface connection element;
activating the card using the biometric reader element;
reverifying the identity of the client using any of the password, personal identification number (PIN), identifying code and biometric reader element;
determining a geographic location of the computer;
using the selection device to select one of the instruction sets and one of the data sets;
executing the instruction set using the data set to connect the computer to the online gambling website;
verifying that the geographic location is in a same gambling jurisdiction (same state or same foreign country) as the geographic address of the gambling institution; and
permitting online gambling using a client account linked to the card.

(21) In a further variant, the method of using an electronic multipurpose card for online gambling further includes the step of terminating online gambling upon removal of the interface connection element from the computer.

(22) In still a further variant, the method of using an electronic multipurpose card for online gambling further includes the steps of encoding either of the magnetic stripe memory element and the programmable memory connected to the interface connection element for use with point of sale devices that include dedicated gambling machines, hotel room doors, vending machines and automatic teller machines and using either of the magnetic stripe memory element and the programmable memory connected to the interface connection element to connect the card to the point of sale devices without need for connection to a computer.

(23) In yet a further variant, the method of using an electronic multipurpose card for online gambling further includes the step of permitting the client to either of create, view and modify a membership profile linked to the client account.

(24) In another variant of the invention, the method of using an electronic multipurpose card for online gambling further includes the step of permitting the client to view and operate rewards programs and special offers associated with the account.

(25) In still another variant, the method of using an electronic multipurpose card for online gambling further includes the step of providing software linked to the at least one online gambling website adapted to detect and prevent use of any of proxy servers and other methods and devices to disguise client location.

(26) In yet another variant, a method of using an electronic multipurpose card for managing healthcare data includes the steps of:
providing an electronic multipurpose card includes:
   a biometric reader element for activating the card;
   at least one interface connection element for connection to an external computer processor;
   a programmable memory connected to the interface connection element;
   at least one port, the port receiving at least one additional memory module;
   a programmable magnetic stripe memory element;
   an application program, the program selecting among alternative data sets input by either of a card issuer and a card user;
   the program selecting among alternative instruction sets input by either of the card issuer and the card user; and
   a selection device, the device activated by the card user to operate the application program and effect selection of any of the alternative data sets and the alternative instruction sets.
providing at least one healthcare information website, the website has a website address and includes software adapted to manage and provide security for patient healthcare information obtained from a patient, health care providers and insurance companies at a plurality of security levels;
inputting at least one data set to the card includes the healthcare information website address;
inputting at least one instruction set to the card for providing connection to the website address upon activation of the card and patient defined rules for accessing data stored using the plurality of security levels;
verifying an identity of the patient to an operator of the website;
issuing the electronic multipurpose card to the patient;
setting up any of a password, personal identification number (PIN) and identifying code for use by the patient with the card;
attaching the card to a computer using the interface connection element;
activating the card using the biometric reader element;
reverifying the identity of the patient using any of the password, personal identification number (PIN), identifying code and biometric reader element;
   using the selection device to select one of the instruction sets and one of the data sets;
   executing the instruction set using the data set to connect the computer to the healthcare information website; and
   permitting access to the patient's medical information based upon the patient defined rules for accessing data stored using the plurality of security levels.

(27) In a further variant, the method of using an electronic multipurpose card for managing healthcare data further includes the step at providing emergency contact information for the client.

(28) In still a further variant, the method of using an electronic multipurpose card for managing healthcare data further includes the step of providing a data set containing emergency rules for handling emergency situations when the patient cannot provide input to his care.

(29) In yet a further variant, the method of using an electronic multipurpose card for managing healthcare data further includes the step of providing patient selectable rules for distribution of healthcare information to third parties by those permitted access by the patient.

(30) In a final variant, the method of using an electronic multipurpose card for managing healthcare data further includes the step of providing patient healthcare insurance information with security for such information determined by patient input rules.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention illustrating an add-on memory port;

FIG. 2 is a perspective view of another embodiment with an embedded memory module and add-on memory port;

FIG. 3 is a plan view of the invention illustrating the connections to the onboard microprocessor, memory and RFID circuit;

FIG. 4 is a plan view of the invention illustrating a QR code on the card;

FIG. 5 is a perspective view of another embodiment illustrating a biometric sensor and a holographic code;

FIG. 6 selection buttons, a finger print scanner and a bar code on the card;

FIG. 7 is a is a perspective view of a computer processor for connection to the invention;

FIG. 8 is a is a perspective view of a tablet computer used for selection of card functions;

FIG. 9 is a is a perspective view of a mobile phone used for selection of card functions;

FIG. 10 is a is a plan view of another embodiment illustrating a Bluetooth® connection device;

FIG. 11 is a is a plan view of another embodiment illustrating a wireless connection device;

FIG. 12 is a schematic of instruction sets for storage on the card;

FIG. 13 is a schematic of data sets for storage on the card;

FIG. 14 is a perspective view of a mobile phone case and mobile phone with a card reading slot;

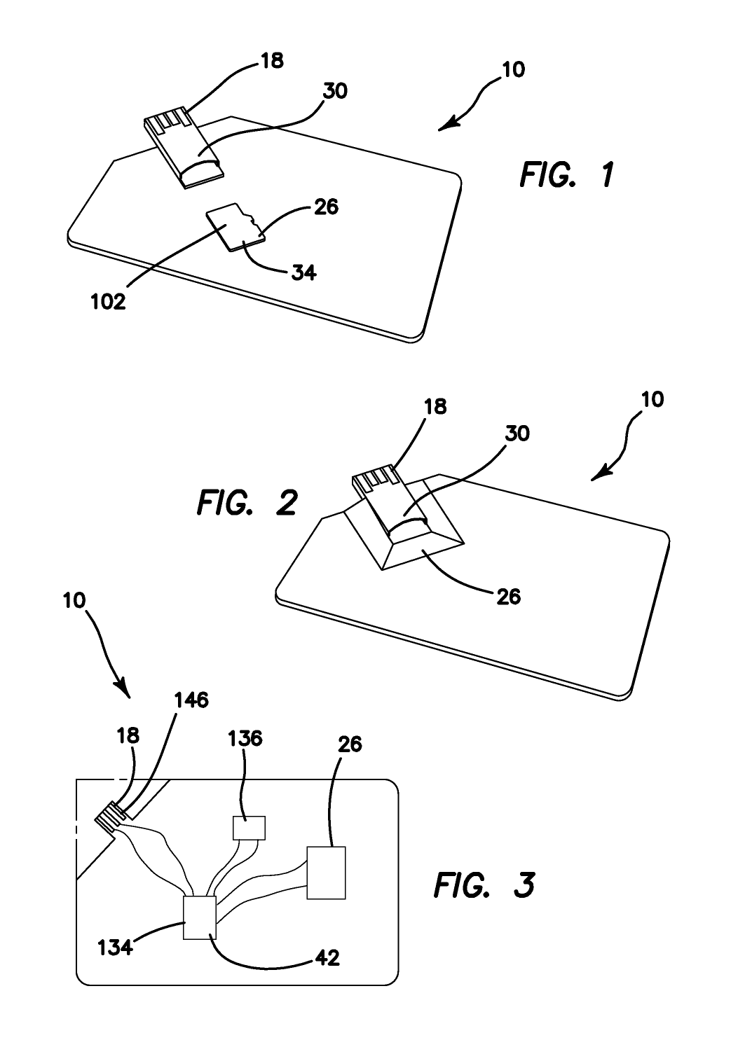

FIG. 11 is a partial perspective view of the bag pack support tray of the FIG. 1 embodiment illustrating a laterally movable/removable bag securing hook; and

FIG. 15 is a schematic of a recharged debit card being used for an electronic payment;

FIG. 16 is a is a perspective view of another embodiment illustrating a standard USB connector on the card;

FIG. 17 is a is a perspective view of another embodiment illustrating a mini-USB connector on the card;

FIG. 18 is a is a perspective view of another embodiment illustrating a micro-USB connector on the card;

FIG. 19 is a is a perspective view of another embodiment illustrating an Apple® proprietary connector on the card;

FIG. 20 is a is a perspective view of another embodiment illustrating a finger print scanner on the card;

FIG. 21 is a is a perspective view of another embodiment illustrating a retinal scanner on the card;

FIG. 22 is a is a perspective view of another embodiment illustrating a face recognition scanner on the card; and

FIG. 23 is a is a perspective view of another embodiment illustrating a skin conductivity scanner on the card;

### DETAILED DESCRIPTION OF THE PREFERRED EMBODIMENT

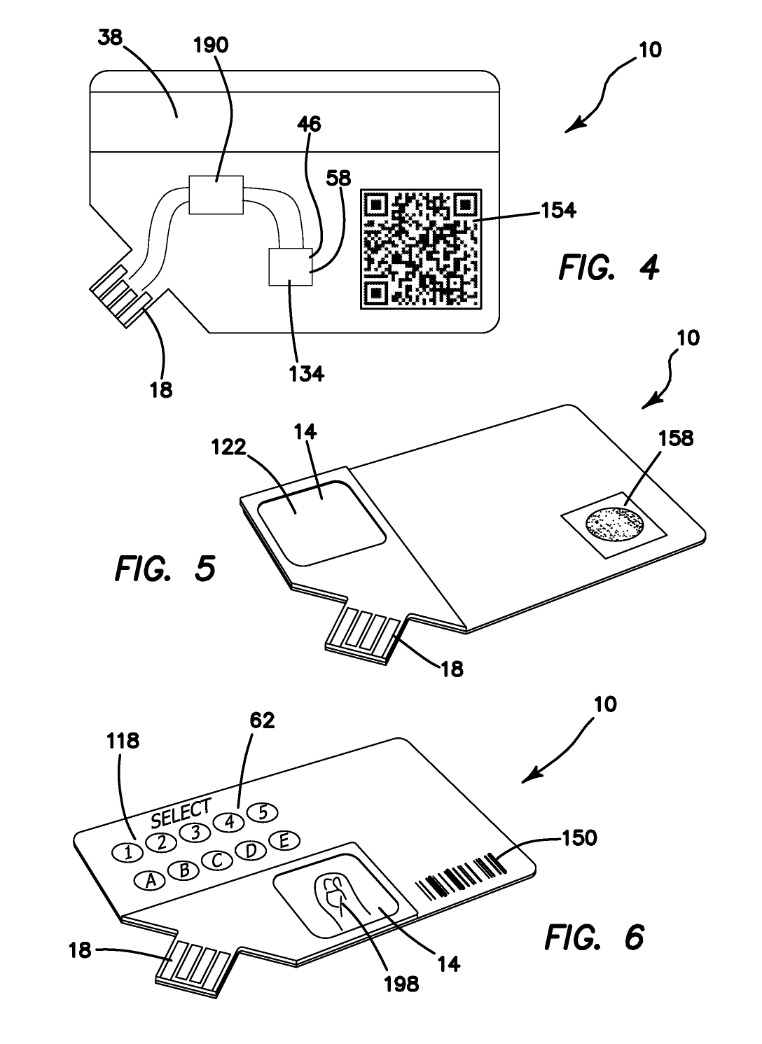

(1) FIGS. 1-15 illustrate an electronic multipurpose card 10 providing the desired features that may be constructed from the following components. As illustrated in FIGS. 5 and 6, a biometric reader element 14 for activating the card 10 is provided. As illustrated in FIGS. 1-6, 10 and 11, at least one interface connection element 18 for connection to an external computer processor 22 is provided. A programmable memory 26 connected to the interface connection element 18 is provided. As illustrated in FIGS. 1 and 2, at least one port 30 is provided. The port 30 receives at least one additional memory module 34. As illustrated in FIG. 4 a programmable magnetic stripe memory element 38 is provided.

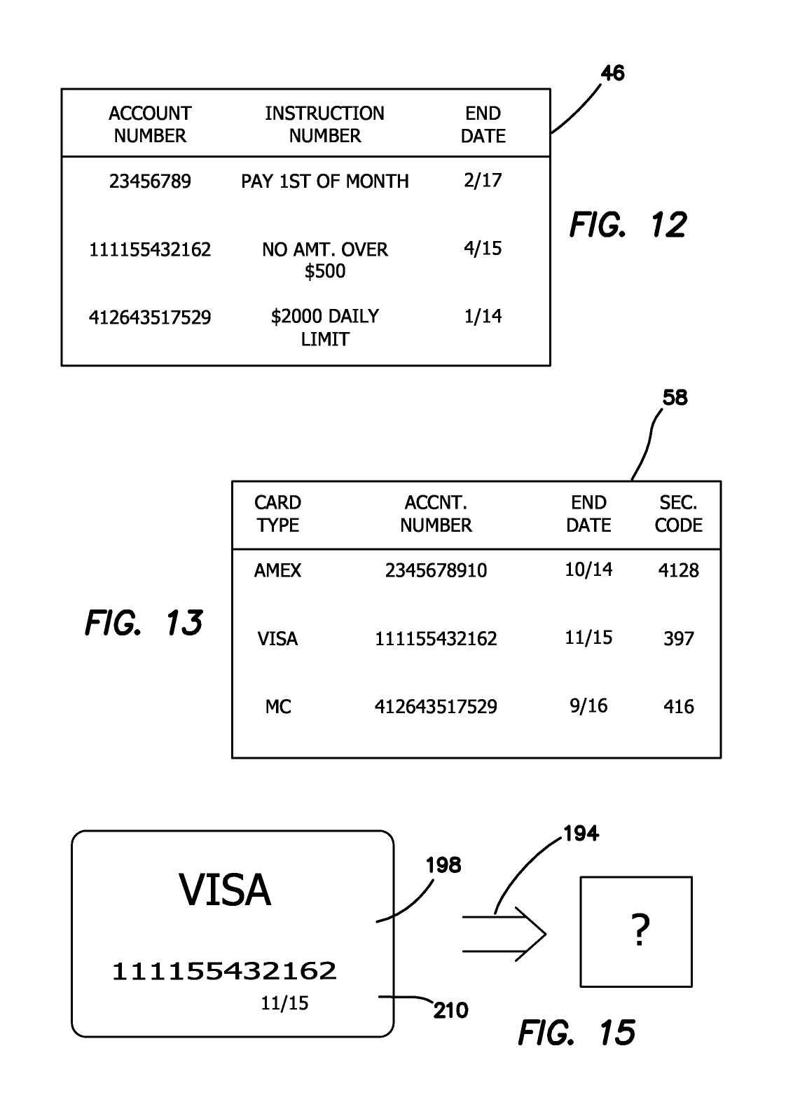

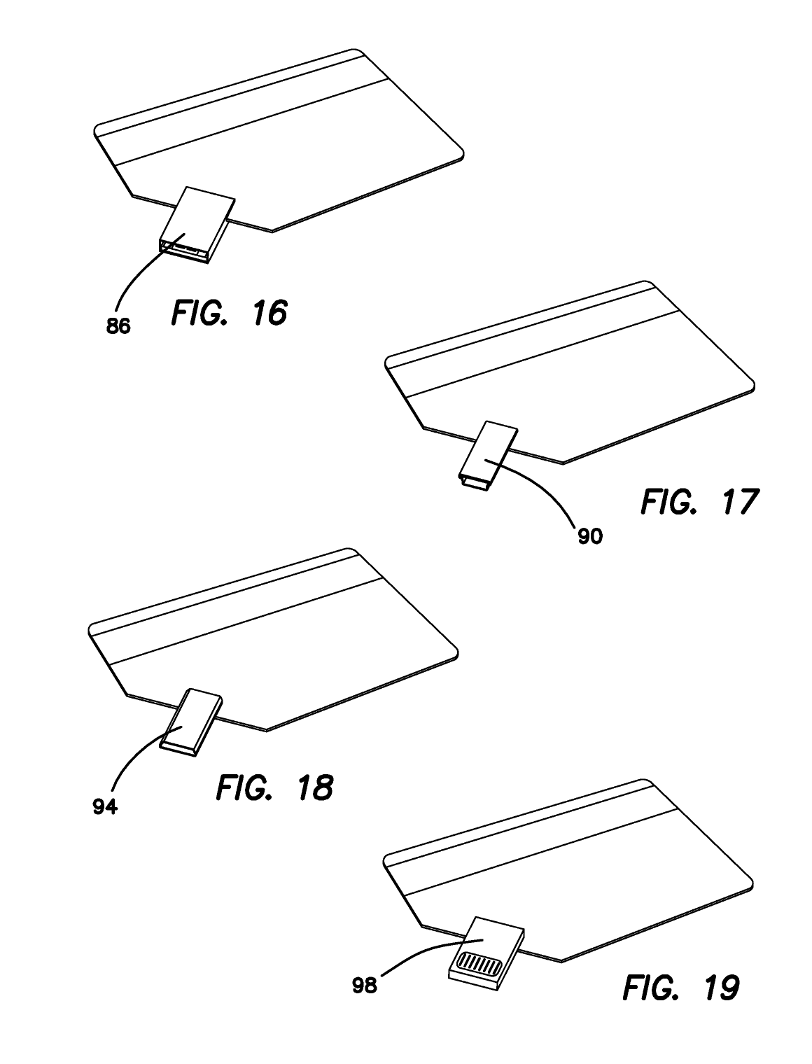

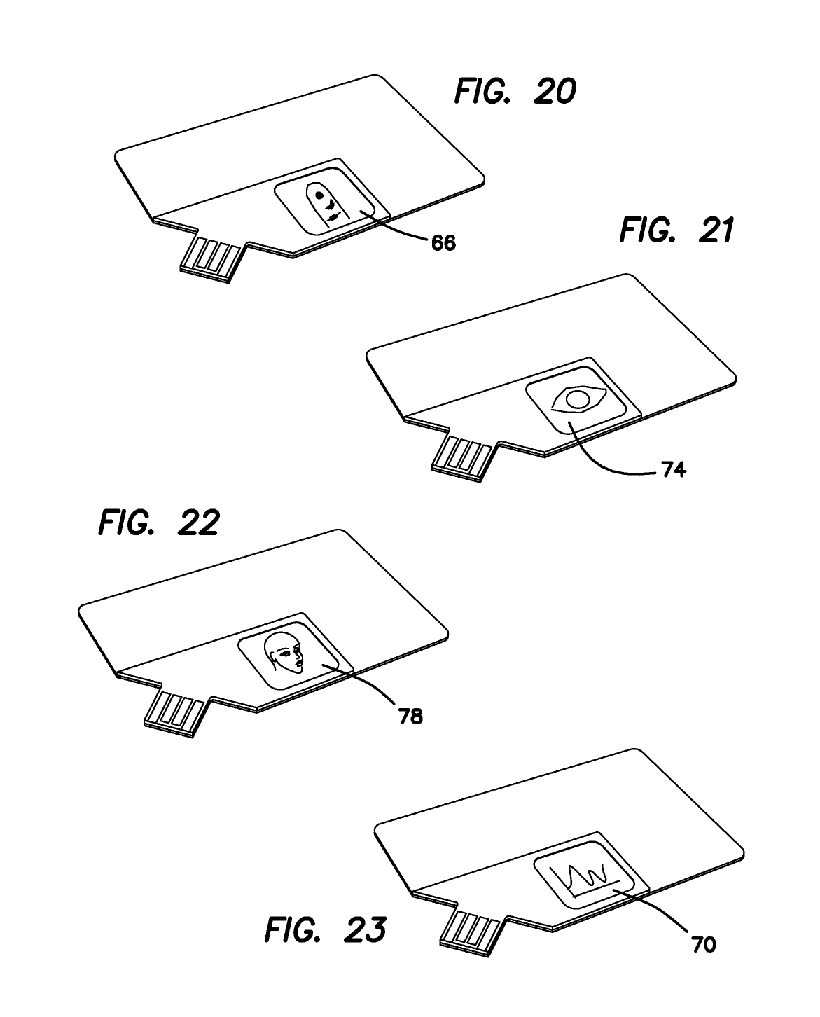

As illustrated in FIGS. 3, 4, 10 and 11, an application program 42 is provided. As illustrated in FIGS. 12 and 13, the program 42 selects among alternative data sets 46 input by either of a card issuer 50 or a card user 54. The program 42 selects among alternative instruction sets 58 input by either of the card issuer (not shown) or the card user (not shown). A selection device 62 is provided. The device 62 is activated by the card user to operate the application program 42 and effect selection of any of the alternative data sets 46 and the alternative instruction sets 58.

(2) In another variant of the invention, as illustrated in FIGS. 6 and 20-23, the biometric reader element 14 is selected from the group that includes fingerprint reader 66, skin conductivity reader 70, retinal scanner 74, facial recognition system 78 and embedded chip detector 82.

(3) In still another variant, as illustrated in FIGS. 16-19 the at least one interface connection element 18 is selected from the group that includes USB connector 86, mini USB connector 90, micro USB connector 94 and Apple® proprietary connector 98.

(4) In a further variant, as illustrated in FIGS. 2-3, 10 and 11, the programmable memory 26 is imbedded in the card 10.

(5) In still a further variant, as illustrated in FIG. 1, the additional memory module 34 is selected from the group that includes SD® cards 102, Memory Sticks® (not shown), Compact Flash® cards (not shown), and Smart Memory® cards (not shown).

(6) In yet a further variant, as illustrated in FIG. 6, the selection device 62 is an array of switches 118 attached to the card 10.

(7) In another variant of the invention, as illustrated in FIGS. 5, 7 and 8, the selection device 62 is any of a touchscreen 122 on the card 10, a remotely connected keyboard 126 and a remotely connected touchscreen 130.

(8) In still another variant, as illustrated in FIGS. 3 and 4, an onboard microprocessor 134 connected to the at least one interface connection element 118 is provided.

(9) In a further variant, as illustrated in FIG. 3, a radio frequency identification device (RFID) 136 is connected to the programmable memory 26.

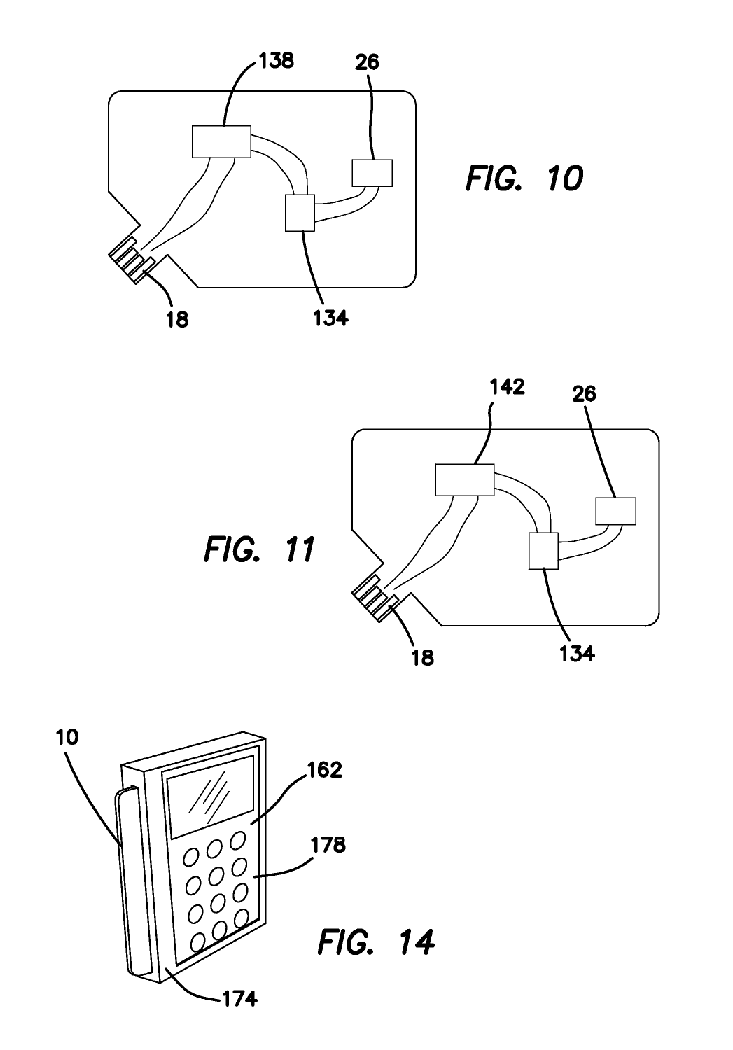

(10) In still a further variant, the electronic multipurpose card 10 further includes any of a Bluetooth® connection device 138 (FIG. 10), wireless connection device 142 (FIG. 11) or wired connection 146 (FIG. 3).

(11) In yet a further variant, as illustrated in FIG. 6, the electronic multipurpose card 10 further includes a scannable, identifying barcode 150.

(12) In another variant of the invention, any of as two dimensional, scannable, identifying barcode (QR code) 154 (FIG. 4) and three dimensional holographic code 158 (FIG. 5) is provided.

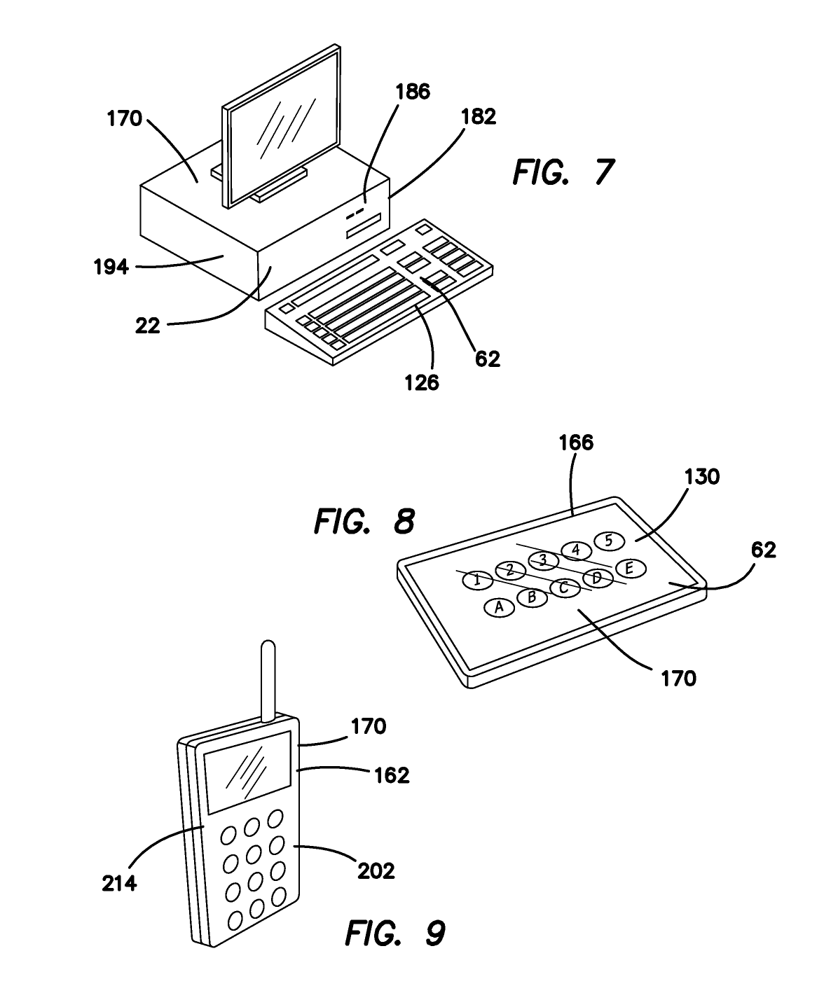

(13) In still another variant, any of a mobile phone 162, (FIG. 9) tablet computer 166 (FIG. 8) and other computer-based application program 170 (FIG. 7) is provided. The program 170 connects to and interfaces with either of the onboard microprocessor 134 and the programmable memory 26 through the at least one interface connection element 18.

(14) In yet another variant, as illustrated in FIG. 14, a mobile phone case 174 is provided. The case 174 is adapted to connect the card 10 to a mobile phone 162. The phone 162 provides the application program 178 to interlace with either of the onboard microprocessor 134 or the programmable memory 26.

(15) In a further variant, as illustrated in FIG. 7, a Web-based 182 or local 186 computer-based application program is provided. The program 182, 186 connects to and interfaces with either of the onboard microprocessor 134 or the programmable memory 26 through the at least one interface connection element 18.

(16) In still a further variant, as illustrated in FIG. 4, a time delay system 190 is provided. The time delay system 190 renders data sets 46 or instruction sets 58 available from the card 10 unreadable by external devices 194 after a preselected time period without renewed authorizing input 198 from a card user 54.

(17) In yet a further variant, data sets 46 or instruction sets 58 on the card 10 are transmitted to an external memory device through the at least one interface connection element.

(18) In another variant of the invention, as illustrated in FIGS. 9 and 15, data sets 46 or instruction sets 58 on the card 10 are used to supplement a payment 194 made with another card 198 or device 202.

(19) In a still another variant, as illustrated in FIGS. 9 and 15, data sets 46 or instruction sets 58 on thee card 10 are used to access a user's financial institution 206 to recharge the card 10 for use as any of a debit card 210 and financial transaction device 214 for further transactions.

(20) In yet another variant, a method of using an electronic multipurpose card 10 for online gambling includes the steps of:
providing an electronic multipurpose card 10 that includes:
   a biometric reader element 14 for activating the card 10;
   at least one interface connection element 18 for connection to an external computer processor 22;
   a programmable memory 26 connected to the interface connection element 18;
   at least one port 30, the port 30 receiving at least one additional memory module 34;
   a programmable magnetic stripe memory element 38:
   an application program 42, the program 42 selecting among alternative data sets 46 input by either of a card issuer and a card user;
   the program 42 selecting among alternative instruction sets 58 input by either of the card issuer and the card user; and
   a selection device 62, the device 62 activated by the card user to operate the application program 42 and effect selection of any of the alternative data sets 46 and the alternative instruction sets 58.
providing at least one online gambling website (not shown), the website has a website address (not shown) and includes software (not shown) adapted to determine a geographic location for any electronic device 22, 162 connecting to the website;
inputting at least one data set 58 to the card 10 that includes the online gambling website address and a geographic address (not shown) of a gambling institution;
inputting at least one instruction set 46 to the card 10 for providing connection to the website address upon activation of the card 10;
verifying an identity of a client of the gambling institution (not shown);
issuing the electronic multipurpose card 10 to the client;
setting up any of a password, personal identification number (PIN) and identifying code (not shown) for use by the client with the card 10;
attaching the card 10 to a computer 22 using the interface connection element 18;
activating the card 10 using the biometric reader element 14;
reverifying the identity of the client using any of the password, personal identification number (PIN), identifying code and biometric reader element 14;
determining a geographic location (not shown) of the computer 22;
using the selection device 62 to select one of the instruction sets 58 and one of the data sets 46;
executing the instruction set 58 using the data set 46 to connect the computer 22 to the online gambling website;
verifying that the geographic location is in a same gambling jurisdiction (same state or same foreign country) (not shown) as the geographic address of the gambling institution (not shown); and
permitting online gambling using a client account 58 linked to the card 10.

(21) In a further variant, the method of using an electronic multipurpose card 10 for online gambling further includes the step of terminating online gambling upon removal of the interface connection element 18 from the computer 22.

(22) In still a further variant, the method of using an electronic multipurpose card 10 for online gambling further includes the steps of encoding either of the magnetic stripe memory element 38 and the programmable memory 26 connected to the interface connection element 18 for use with point of sale devices that include dedicated gambling machines, hotel room doors, vending machines and automatic teller machines (not shown) and using either of the magnetic stripe memory element 38 and the programmable memory 26 connected to the interface connection element 18 to connect the card 10 to the point of sale devices without need for connection to a computer 22.

(23) In yet a further variant, the method of using an electronic multipurpose card 10 for online gambling further includes the step of permitting the client to either of create, view and modify a membership profile (not shown) linked to the client account 58.

(24) In another variant of the invention, the method of using an electronic multipurpose card 10 for online gambling further includes the step of permitting the client to view and operate rewards programs and special offers (not shown) associated with the account 58.

(25) In still another variant, the method of using an electronic multipurpose card 10 for online gambling further includes the step of providing software (not shown) linked to the at least one online gambling website adapted to detect and prevent use of any of proxy servers and other methods and devices (not shown) to disguise client location.

(26) In yet another variant, a method of using an electronic multipurpose card 10 for managing healthcare data (not shown) includes the steps of:
providing an electronic multipurpose card 10 that includes:
   a biometric reader element 14 for activating the card 10;
   at least one interface connection element 18 for connection to an external computer processor 22;
   a programmable memory 26 connected to the interface connection element 18;
   at least one port 30, the port 30 receiving at least one additional memory module 34;
   a programmable magnetic stripe memory element 38;
   an application program 42, the program 42 selecting among alternative data sets 46 input by either of a card issuer and a card user;
   the program 42 selecting among alternative instruction sets 58 input by either of the card issuer and the patient (not shown); and
   a selection device 62, the device 62 activated by the card user to operate the application program 42 and effect selection of any of the alternative data sets 46 and the alternative instruction sets 58.
providing at least one healthcare information website (not shown), the website has a website address (not shown) and includes software (not shown) adapted to manage and provide security for patient healthcare information obtained from a patient, health care providers and insurance companies at a plurality of security levels (not shown);
inputting at least one data set 58 to the card 10 that includes the healthcare information website address;
inputting at least one instruction set 46 to the card 10 for providing connection to the website address upon activation of the card 10 and patient defined rules for accessing data stored using the plurality of security levels (not shown);
verifying an identity of the patient to an operator of the website (not shown);
issuing the electronic multipurpose card 10 to the patient;
setting up any of a password, personal identification number (PIN) and identifying code for use by the patient with the card (not shown);
attaching the card 10 to a computer 22 using the interface connection element 18;
activating the card 10 using the biometric reader element 14;
reverifying the identity of the patient using any of the password, personal identification number (PIN), identifying code and biometric reader element 14;
using the selection device 62 to select one of the instruction sets 58 and one of the data sets 46;
executing the instruction set 58 using the data set 46 to connect the computer 22 to the healthcare information website; and
permitting access to the patient's medical information based upon patient defined rules for accessing data stored using the plurality of security levels.

(27) In a further variant, the method of using an electronic multipurpose card 10 for managing healthcare data further includes the step of providing emergency contact information (not shown) for the client.

(28) In still a further variant, the method of using an electronic multipurpose card 10 for managing healthcare data further includes the step of providing a data set 58 containing emergency rules for handling emergency situations when the patient cannot provide input to his care.

(29) In yet a further variant, the method of using an electronic multipurpose card 10 for managing healthcare data further includes the step of providing patient selectable rules 46 for distribution of healthcare information to third parties by those permitted access by the patient.

(30) In a final variant, the method of using an electronic multipurpose card 10 for managing healthcare data further includes the step of providing patient healthcare insurance information (not shown) with security for such information determined by patient input rules 46.

The electronic multipurpose card 10 and methods of using same have been described with reference to particular embodiments. Other modifications and enhancements can be made without departing from the spirit and scope of the claims that follow.

1. An electronic multipurpose card, comprising:
a biometric reader element for activating the card;
at least one interface connection element for connection to an external computer processor;
a programmable memory connected to said interlace connection element;
at least one port, said port receiving at least one additional memory module;
a programmable magnetic stripe memory element;
an application program, said program selecting among alternative data sets input by either of a card issuer and a card user;
said program selecting among alternative instruction sets input by either of said card issuer and said card user; and
a selection device, said device activated by said card user to operate said application program and effect selection of any of said alternative data sets and said alternative instruction sets.

2. The electronic multipurpose card, as described in claim 1, wherein said biometric reader element is selected from the group comprising:
fingerprint reader, skin conductivity reader, retinal scanner, facial recognition system and embedded chip detector.

3. The electronic multipurpose card, as described in claim 1, wherein said at least one interface connection element is selected from the group comprising:
USB connector, mini USB connector, micro USB connector and Apple® proprietary connector.

4. The electronic multipurpose card, as described in claim 1, wherein said programmable memory is imbedded in said card.

5. The electronic multipurpose card, as described in claim 1, wherein said additional memory module is selected from the group comprising:
SD® cards, Memory Sticks®, Compact Flash® cards, and Smart Memory® cards.

6. The electronic multipurpose card, as described in claim 1, wherein said selection device is an array of switches attached to said card.

7. The electronic multipurpose card, as described in claim 1, wherein said selection device is any of a touchscreen on said card, a remotely connected keyboard and a remotely connected touchscreen.

8. The electronic multipurpose card, as described in claim 1, further comprising an onboard microprocessor connected to said at least one into connection element.

9. The electronic multipurpose card, as described in claim 1, further comprising a radio frequency identification device (RFID) connected to said programmable memory.

10. The electronic multipurpose card, as described in claim 1, further comprising any of a Bluetooth® connection device, wireless connection device or wired connection.

11. The electronic multipurpose card, as described in claim 1, further comprising a scannable, identifying barcode.

12. The electronic multipurpose card, as described in claim 1, further comprising any of a two dimensional, scannable, identifying barcode (QR code) and three dimensional holographic code.

13. The electronic multipurpose card, as described in claim 8, further comprising any of a mobile phone, tablet computer and other computer-based application program, said program connecting to and interfacing with either of said onboard microprocessor and said programmable memory through said at least one interface connection element.

14. The electronic multipurpose card, as described in claim 13, further comprising a mobile phone case, said case adapted to connect said card to a mobile phone, said phone providing said application program to interface with either of said onboard microprocessor and said programmable memory.

15. The electronic multipurpose card, as described in claim 8, further comprising a Web-based or local computer-based application program, said program connecting to and interfacing with either of said onboard microprocessor and said programmable memory through said at least one interface connection element.

16. The electronic multipurpose card, as described in claim 1, further comprising a time delay system, said time delay system rendering either of data sets and instruction sets available from said card unreadable by external devices after a preselected time period without renewed authorizing input from a card user.

17. The electronic multipurpose card, as described in claim 1, wherein either of data sets and instruction sets on said card is transmitted to an external memory device through said at least one interface connection element.

18. The electronic multipurpose card, as described in claim 1, wherein either of data sets and instruction sets on said card is used to supplement a payment made with another card or device.

19. The electronic multipurpose card, as described in claim 1, wherein either of data sets and instruction sets on said card is used to access a user's financial institution to recharge said card for use as any of a debit card and financial transaction device for further transactions.

20. A method of using an electronic multipurpose card for online gambling comprising the steps of:
providing an electronic multipurpose card comprising:
a biometric reader element for activating the card;
at least one interface connection clement for connection to an external computer processor;
a programmable memory connected to said interface connection element;
at least one port, said port receiving at least one additional memory module;
a programmable magnetic stripe memory element;
an application program, said program selecting among alternative data sets input by either of a card issuer and a card user;
said program selecting among alternative instruction sets input by either of said card issuer and said card user; and
a selection device, said device activated by said card user to operate said application program and effect selection of any of said alternative data sets and said alternative instruction sets.
providing at least one online gambling website, said website having a website address and comprising software adapted to determine a geographic location for any electronic device connecting to said website;
inputting at least one data set to said card comprising said online gambling website address and a geographic address of a gambling institution;
inputting at least one instruction set to said card for providing connection to said website address upon activation of said card;
verifying an identity of a client of said gambling institution;
issuing said electronic multipurpose card to said client;
setting up any of a password, personal identification number (PIN) and identifying code for use by said client with said card;
attaching said card to a computer using said interface connection element;
activating said card using said biometric reader element;
reverifying said identity of said client using any of said password, personal identification number (PIN), identifying code and biometric reader element;
determining a geographic location of said computer;
using said selection device to select one of said instruction sets and one of said data sets;
executing said instruction set using said data set to connect said computer to said online gambling website;
verifying that said geographic location is in a same gambling jurisdiction as said geographic address of said gambling institution; and
permitting online gambling using a client account linked to said card.

21. The method of using an electronic multipurpose card for online gambling, as described in claim 20, further comprising the step of terminating online gambling upon removal of said interface connection element from said computer.

22. The method of using an electronic multipurpose card for online gambling, as described in claim 20, further comprising the steps of:
encoding either of said magnetic stripe memory element and said programmable memory connected to said interface connection element for use with point of sale devices comprising dedicated gambling machines, hotel room doors, vending machines and automatic teller machines;
using either of said magnetic stripe memory element and said programmable memory connected to said interface connection element to connect said card to said point of sale devices without need for connection to a computer.

23. The method of using an electronic multipurpose card for online gambling, as described in claim 20, further comprising the step of permitting said client to either of create, view and modify a membership profile linked to said client account.

24. The method of using an electronic multipurpose card for online gambling, as described in claim 20, further comprising the step of permitting said client to view and operate rewards programs and special offers associated with said account.

25. The method of using an electronic multipurpose card for online gambling, as described in claim 20, further comprising the step of providing software linked to said at least one online gambling website adapted to detect and prevent use of any of proxy servers and other methods and devices to disguise client location.

26. A method of using an electronic multipurpose card for managing healthcare data comprising the steps of:
providing an electronic multipurpose card comprising:
a biometric reader element for activating the card;
at least one interface connection element for connection to an external computer processor;
a programmable memory connected to said interface connection element;
at least one port, said port receiving at least one additional memory module;
a programmable magnetic stripe memory element;
an application program, said program selecting among alternative data sets input by either of a card issuer and a card user;
said program selecting among alternative instruction sets input by either of said card issuer and said card user; and
a selection device, said device activated by said card user to operate said application program and effect selection of any of said alternative data sets and said alternative instruction sets.
providing at least one healthcare information website, said website having a website address and comprising software adapted to manage and provide security for patient healthcare information obtained from a patient, health care providers and insurance companies at a plurality of security levels;
inputting at least one data set to said card comprising said healthcare information website address;
inputting at least one instruction set to said card for providing connection to said website address upon activation of said card and patient defined rules for accessing data stored using said plurality of security levels;
verifying an identity of said patient to an operator of said website;
issuing said electronic multipurpose card to said patient;
setting up any of a password, personal identification number (PIN) and identifying code for use by said patient with said card;
attaching said card to a computer using said interface connection element;
activating said card using said biometric reader element;
reverifying said identity of said patient using any of said password, personal identification number (PIN), identifying code and biometric reader element;
using said selection device to select one of said instruction sets and one of said data sets;
executing said instruction set using said data set to connect said computer to said healthcare information website; and
permitting access to said patient's medical information based upon said patient defined rules for accessing data stored using said plurality of security levels.

27. The method of using an electronic multipurpose card for managing healthcare data, as described in claim 26, further comprising the step of providing emergency contact information for said client.

28. The method of using an electronic multipurpose card for managing healthcare data, as described in claim 26, further comprising the step of providing a data set containing emergency rules for handling emergency situations when said patient cannot provide input to his care.

29. The method of using an electronic multipurpose card for managing healthcare data, as described in claim 26, further comprising the step of providing patient selectable rules for distribution of healthcare information to third parties by those permitted access by said patient.

30. The method of using an electronic multipurpose card for managing healthcare data, as described in claim 26, further comprising the step of providing patient healthcare insurance information with security for such information determined by patient input rules.
